(19) United States
(12) Patent Application Publication
(10) Pub. No.: US 2008/0025448 A1
(43) Pub. Date: Jan. 31, 2008

(54) Jitter characterization

(76) Inventors: Marlin Viss, Santa Rosa, CA (US); Mark Joseph Woodward, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/494,679

(22) Filed: Jul. 27, 2006

(51) Int. Cl. H04L 7/00

(52) U.S. Cl. 375/355

(57) ABSTRACT

A signal sampling system includes a plurality of samplers that sample a signal. A signal processor processes samples acquired by the plurality of samplers in order to characterize jitter present in the signal. A set of samples is taken for a periodically repeating signal edge. The set of samples includes one sample from each sampler in the plurality of samplers. Each sample in the set of samples is taken at a different time. The signal processor evaluates values of samples within the set of samples to characterize jitter.

### BACKGROUND

High speed signals in communication systems are often corrupted by signal timing instabilities, typically referred to as signal jitter. Signal jitter can include various components, such as random jitter, data dependent jitter, and periodic jitter. Characterizing components of the jitter enables designers of a communications system to establish sources of jitter and predict the bit error rate of the communication system.

Sampling systems, such as equivalent-time sampling oscilloscopes, are well-suited for characterizing high speed signals that have repetitive bit patterns. Highly stable time bases within the sampling systems also make the sampling systems suitable for characterizing jitter.

### SUMMARY OF THE INVENTION

In accordance with embodiments of the present invention, a signal sampling system includes a plurality of samplers that sample a signal. A signal processor processes samples acquired by the plurality of samplers in order to characterize jitter present in the signal. A set of samples is taken for the periodically repeating signal edge. The set of samples includes one sample from each sampler in the plurality of samplers. Each sample in the set of samples is taken at a different time. The signal processor evaluates values of samples within the set of samples to characterize jitter.

### BRIEF DESCRIPTION OF THE DRAWINGS

FIG. 1 is a block diagram showing a sampling system used to characterize jitter in accordance with an embodiment of the present invention.

FIG. 2 is a simplified flowchart describing a process used in the characterization of jitter in accordance with an embodiment of the present invention.

FIG. 3 is a simplified timing diagram illustrating timing of a sampling system used to characterize jitter in accordance with an embodiment of the present invention.

FIG. 4 is a block diagram showing a sampling system used to characterize jitter in accordance with another embodiment of the present invention.

FIG. 5 is a block diagram showing a sampling system used to characterize jitter in accordance with another embodiment of the present invention.

### DESCRIPTION OF THE EMBODIMENT

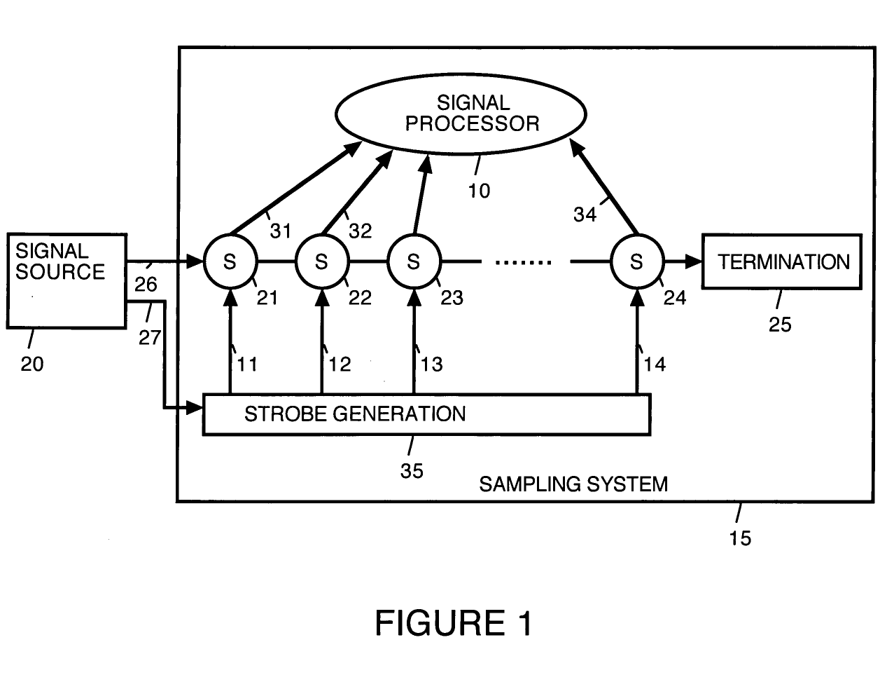

FIG. 1 shows a sampling system 15 suitable for characterizing jitter for a signal 26 from a signal source 20. Signal 26 is typically a high speed data signal, or other signal, having an associated bit rate and pattern length. Signal source 20 is typically a communication system, network node, instrument device or some other element that provides signal 26 to sampling system 15. Sampling system 15, for example, can be an equivalent-time sampling oscilloscope, signal digitizer, analog-to-digital converter or other suitable sample acquisition system.

Signal source 20 also provides a trigger signal 27 that provides a timing reference for the acquisition of samples by sampling system 15. While FIG. 1 shows use of trigger signal 27, in alternative embodiments, it is possible to omit trigger signal 27, in which case sampling system 15 can derive a timing reference from signal 26.

In the embodiment shown in FIG. 1, sampling system 15 uses a matrix of samplers. The matrix of samplers is illustrated in FIG. 1 by a sampler 21, a sampler 22, a sampler 23 and a sampler 24. The number of samplers used depends upon the range from a signal edge over which jitter from signal 26 is to be detected. Each of samplers 21 through 24 is, for example, a sampler similar to that disclosed in U.S. Pat. No. 4,956,568 or another type of sampler as is selected to be optimal for a particular application.

Each sampler in the matrix of samplers is individually controlled by a separate strobe signal. For example, as shown in FIG. 1, sampler 21 is controlled by a strobe signal 11. Sampler 22 is controlled by a strobe signal 12. Sampler 23 is controlled by a strobe signal 13. Sampler 24 is controlled by a strobe signal 14. Strobe generation 35 generates strobe signals 11 through 14 based on trigger signal 27. Alternatively, strobe generation 35 can generate strobe signals 11 through 14 based on a timing reference derived from signal 26.

In FIG. 1, the matrix of samplers is arranged in a serial topology. Alternatively, other topologies can be utilized. In the serial topology shown in FIG. 1, each of samplers 21 through 24 function as pass through samplers. That is, signal 26 passes through sampler 21 to get to sampler 22. Signal 26 passes through sampler 22 to get to sampler 23. Signal 26 passes through sampler 23 to get to sampler 24. Signal 26 passes through sampler 24 to get to a termination 25. For example, termination 25 is a 50 ohm termination.

When each sampler samples signal 26 a sample output signal is generated. For example, when sampler 21 samples signal 26 a sample output signal 31 is generated. When sampler 22 samples signal 26 a sample output signal 32 is generated. When sampler 23 samples signal 26 a sample output signal 33 is generated. When sampler 24 samples signal 26 a sample output signal 34 is generated.

A signal processor 10 initiates sample acquisitions and processes acquired samples to characterize the jitter present in signal 26. For example, signal processor 10 characterizes jitter by targeting samples on particular timing events within a repeating pattern. For example, signal processor 10 targets samples on periodically repeating signal edges that occur within signal 26. A periodically repeating signal edge can be, for example, a signal edge formed by a low-to-high voltage transition in signal 26 or a signal edge formed by a high-to-low voltage transition in signal 26. For example, signal processor 10 targets a sample to be taken when a signal edge is expected to be 50% completed with a transition. Because of jitter, the actual sample point may be either earlier or later than the 50% point of the transition. For each sample, the detected voltage resulting from the sample indicates where in the voltage transition of the signal edge that the sample was actually taken. Signal processor 10 then converts the detected voltage value to an estimated value for jitter.

For example, it can be assumed that the periodically repeating signal edge has a constant slope so that the voltage transition happens at a constant rate. When using this type of approximation, amount of jitter is approximated by multiplication of a voltage difference by a constant. Alternatively, more complicated approaches can be used to model the shape of the periodically repeating signal edge in order to approximate the amount of jitter. For more information on calculating jitter based on sampling at a signal edge, see United States Patent Application Publication 2004/0146097, which is incorporated herein by reference and see United States Patent Application Publication 2005/0086016, which is also incorporated herein by reference.

A signal edge resulting from a voltage transition has a limited duration. Therefore, when a single sampler is used to sample the signal edge, the sample must be taken during the voltage transition in order to provide a valid datum for determining jitter. When jitter causes a signal edge to occur before or after a sample is taken, there is not sufficient information available from the sample to make an accurate approximation of the amount of jitter. For example, if the duration of a signal edge is 30 picoseconds (ps), there is only a 30 ps range over which a single sample can detect jitter. When a sample is targeted in the center of the duration of the signal edge, and a sample value is taken that is not during the 30 ps duration of the signal edge, the only information from the sample available about the jitter is that the jitter is outside the detectable range. Use of a sampling system with a matrix of samplers, as illustrated by sampling system 15 shown in FIG. 1, allows an extension of the range for which jitter can be approximated.

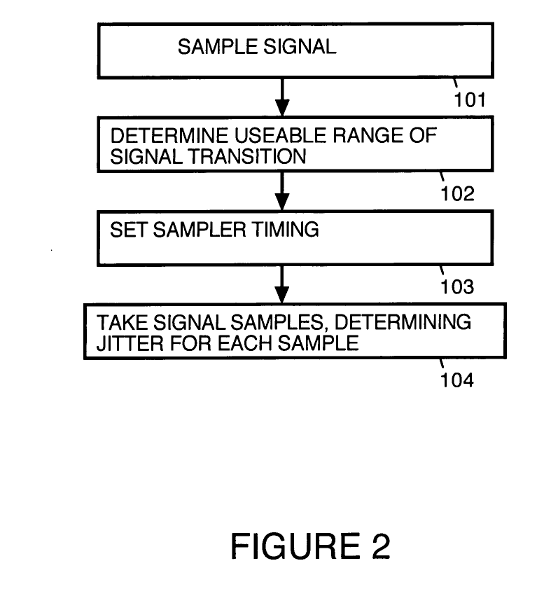

FIG. 2 is a simplified flowchart describing a process by which signal processor 10 characterizes jitter using the matrix of samplers available within sampling system 15. In a block 101, sampling system 15 performs a sufficient number of samples of signal 26 to be able to determine the duration of signal edges.

In a block 102, the “useable range” of the signal edge is determined. What is meant by “useable range” is that portion of the signal edge where the signal edge is steep enough to allow for a high resolution of correlation between sampled voltage value and jitter. For example, the center 80% of the signal edge is used. This assumes that during the initial 10% of transition and the final 10% of transition, the slope of the signal edge is low enough that it provides for insufficient resolution to accurately approximate jitter.

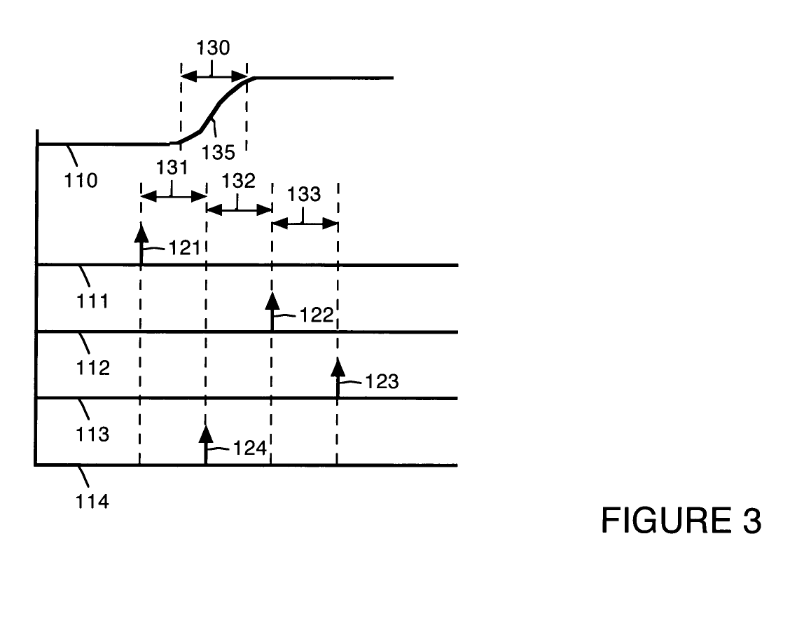

In a block 103, sampler timing is set. For example, the relative spacing between sampling times for samplers 21, 22, 23 and 24 is set equal to the useable range of the signal edge, as determined in block 102. This is illustrated by FIG. 3.

In FIG. 3, waveform 110 represents signal 26 and shows a signal edge 135 of signal 26 being a voltage transition from a lower voltage to a higher voltage. The useable range of the voltage transition is represented by a duration 130. Waveform 111 represents strobe signal 11 used to control timing of sampler 21. A pulse 121 causes sampler 21 to sample signal 26. Waveform 112 represents strobe signal 12 used to control timing of sampler 22. A pulse 122 causes sampler 22 to sample signal 26. Waveform 113 represents strobe signal 13 used to control timing of sampler 23. A pulse 123 causes sampler 23 to sample signal 26. Waveform 114 represents strobe signal 14 used to control timing of sampler 24. A pulse 124 causes sampler 24 to sample signal 26.

In order to extend the range over which jitter can be detected, the duration between which each sampler samples signal 26 is controlled. For example, as shown in FIG. 1, a duration 131 between which sampler 21 samples signal 26 and which sampler 24 samples signal 26 is set equal to duration 130. Likewise, a duration 132 between which sampler 24 samples signal 26 and which sampler 22 samples signal 26 is set equal to duration 130. Likewise, a duration 133 between which sampler 22 samples signal 26 and which sampler 23 samples signal 26 is set equal to duration 130.

When setting sampler timing in block 103, shown in FIG. 2, sampling by one of the middle samplers, in this case sampler 25 or sampler 23, is targeted to occur during a signal edge of signal 26. This allows extension of the range, in both directions, over which jitter may be detected.

In a block 104, shown in FIG. 2, sets of samples of signal 26 are taken, targeting the signal edge by a middle sampler. For each set of samples, each of samplers 21, 22, 23 and 24 takes a single sample at the durations between samples as set in block 103. For each set of samples, it is determined which of the samples occurred during the usable range of the targeted signal edge. For each set of samples, the targeted location of the signal edge is known as well as the relative timing between samples taken by samplers 21, 22, 23 and 24. This allows a jitter value to be determined for each set of samples taken, as long as one of the samples taken by samplers 21, 22, 23 and 24 occurs during the useable range of the targeted signal edge. The jitter value indicates, for example, a difference in time between when the signal edge is targeted to occur verses when the signal edge is detected to occur by the set of samples.

When a matrix of four samplers is used to detect signal jitter, this allows the range over which jitter can be detected to be increased four times over a sampling system that uses only a single sampler. Similarly, when a matrix of three samplers is used to detect signal jitter, this allows the range over which jitter can be detected to be increased three times over a sampling system that uses only a single sampler. Similarly, when a matrix of five samplers is used to detect signal jitter, this allows the range over which jitter can be detected to be increased five times over a sampling system that uses only a single sampler. And so on. The amount of samplers used depends on the detectable range desired.

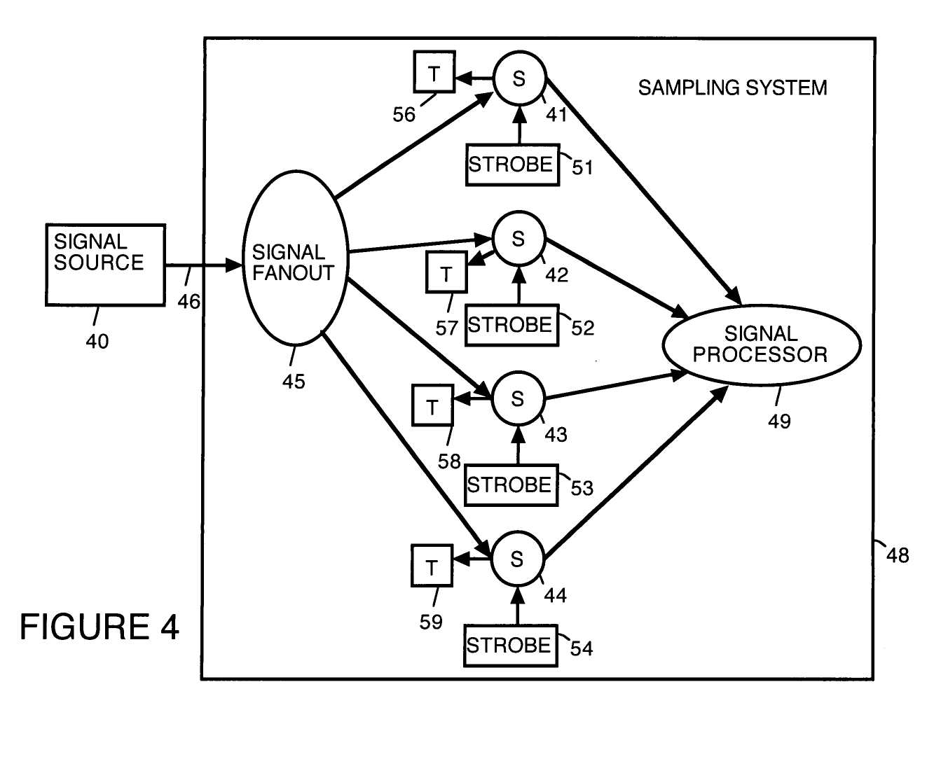

While FIG. 1 shows samplers 21 through 24 arranged in a serial topology, other topologies can be utilized. For example, FIG. 4 is a block diagram of sampling system 48 that utilizes a parallel matrix sampler topology. A signal source 40 provides a signal 46 that is received by a signal fanout 45. Signal fanout 45 provides signal 46 in parallel to a matrix of samplers. The matrix of samplers is illustrated in FIG. 4 by a sampler 41, a sampler 42, a sampler 43 and a sampler 44. The number of samplers used depends upon the desired range over which jitter is to be detected.

Each sampler in the matrix of samplers is individually controlled by a separate strobe signal. For example, as shown in FIG. 4, sampler 41 is controlled by a strobe signal 51. Sampler 42 is controlled by a strobe signal 52. Sampler 43 is controlled by a strobe signal 53. Sampler 44 is controlled by a strobe signal 54. Setting of the duration between which samples are taken within a sampling set is discussed above.

In the parallel topology shown in FIG. 4, each of samplers 41 through 44 is separately terminated. That is, signal 46 passes through sampler 41 and is terminated by a termination (T) 56. Signal 46 passes through sampler 42 and is terminated by a termination (T) 57. Signal 46 passes through sampler 43 and is terminated by a termination (T) 58. Signal 46 passes through sampler 44 and is terminated by a termination (T) 59. For example, terminations 56 through 59 are each a 50 ohm termination.

A signal processor 49 initiates sample acquisitions and processes acquired samples to characterize the jitter present in signal 46. As discussed above, signal processor 49 can characterize jitter by targeting samples on particular timing events within a repeating pattern.

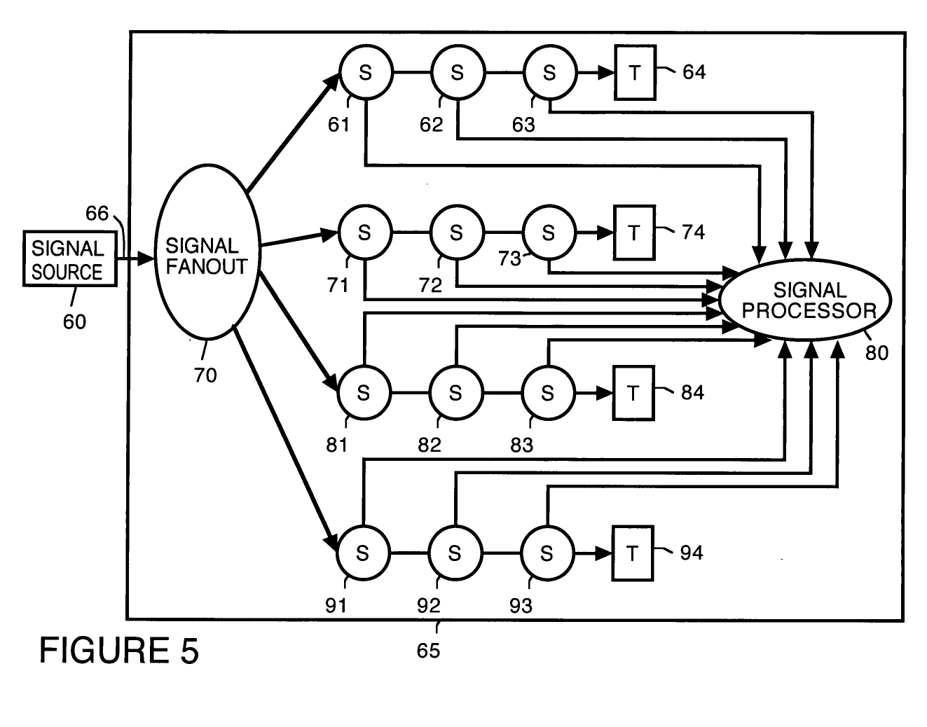

Other sampler topologies can be used as well. For example, FIG. 5 shows a sampling system 65 implemented using a combined serial-parallel matrix sampler topology.

As shown in FIG. 5, a matrix of samplers is composed of a sampler 61, a sampler 62, a sampler 63, a sampler 64, a sampler 71, a sampler 72, a sampler 73, a sampler 74, a sampler 81, a sampler 82, a sampler 83, a sampler 84, a sampler 91, a sampler 92, a sampler 93 and a sampler 94. The number of samplers used depends upon the detectable range desired.

A signal source 60 provides a signal 66 to a signal fanout 70. Signal fanout 70 provides signal 66 to samplers 61, 71, 81 and 91. Signal 66 gets passed through sampler 61, 62 and 63 to termination 64. Similarly, signal 66 gets passed through sampler 71, 72 and 73 to termination 74. Signal 66 gets passed through sampler 81, 82 and 83 to termination 84. Signal 66 gets passed through sampler 91, 92 and 93 to termination 94.

Each sampler in the matrix of samplers shown in FIG. 5 is individually controlled by a separate strobe signal (not shown). A signal processor 80 initiates sample acquisitions and processes acquired samples to characterize the jitter present in signal 66. As discussed above, signal processor 80 can characterize jitter by targeting samples on particular timing events within a repeating pattern.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A signal sampling system comprising:
a plurality of samplers that sample a signal; and,
a signal processor that processes samples acquired by the plurality of samplers in order to characterize jitter present in the signal, wherein a set of samples is taken for a periodically repeating signal edge, the set of samples including one sample from each sampler in the plurality of samplers, each sample in the set of samples being taken at a different time, the signal processor evaluating values of samples within the set of samples to characterize jitter.

2. A signal sampling system as in claim 1 wherein to determine a jitter value, the signal processor uses the values of samples within the set of samples to estimate a difference in time between when the periodically repeating signal edge was targeted to occur and when the periodically repeating signal edge was detected to occur by the plurality of samplers.

3. A signal sampling system as in claim 1 wherein a duration of time between each sample in a set of samples is uniform, the duration of time between each sample being approximately equal to what the signal processor determines to be a duration of a useable range of the periodically repeating signal edge.

4. A signal sampling system as in claim 1 wherein when a sample value from a sample in the set of samples indicates the periodically repeating signal edge occurred at a time in which the sample was taken, the signal processor uses the sample value to determine at what point in the periodically repeating signal edge the sample was taken.

5. A signal sampling system as in claim 1 wherein the plurality of samplers are arranged in a serial topology so that samplers in the plurality of samplers serially receive the signal.

6. A signal sampling system as in claim 1 wherein the plurality of samplers are arranged in a parallel topology so that samplers in the plurality of samplers receive the signal in parallel.

7. A method for characterizing jitter within a signal, the method comprising:
sampling occurrences of a periodically repeating signal edge within the signal using a plurality of samplers, wherein for each sampled occurrence of the periodically repeating signal edge, a set of samples is taken, the set of samples including one sample from each sampler in the plurality of samplers, each sample in the set of samples being taken at a different time; and,
evaluating each set of samples to estimate a length of time between when the periodically repeating signal edge was targeted to occur and when the periodically repeating signal edge was detected to occur by the plurality of samplers.

8. A method as in claim 7 wherein evaluating each set of samples includes setting a jitter value equal to the length of time between when a periodically repeating signal edge was targeted to occur and when the periodically repeating signal edge was detected to occur by the plurality of samplers.

9. A method as in claim 7 wherein sampling occurrences of the periodically repeating signal edge includes maintaining a uniform duration of time between each sample in a set of samples, the uniform duration of time between each sample being approximately equal to what is determined to be a duration of a useable range of the periodically repeating signal edge.

10. A method as in claim 7 wherein evaluating each set of samples to determine the jitter value includes using a sample value from a sample in the set of samples to determine at what point in the periodically repeating signal edge the sample was taken when the sample value indicates the periodically repeating signal edge occurred at a time in which the sample was taken.

11. A method as in claim 7 wherein sampling occurrences of the periodically repeating signal edge includes serially propagating the signal to samplers in the plurality of samplers.

12. A method as in claim 7 wherein sampling occurrences of the periodically repeating signal edge includes propagating in parallel the signal to samplers in the plurality of samplers.

13. A method as in claim 7 wherein before sampling occurrences of the periodically repeating signal edge, the following is performed:
sampling the signal to determine a duration of a useable range of the periodically repeating signal edge.

14. A system that characterizes jitter within a signal, the system comprising:
a plurality of sampling means for sampling occurrences of a periodically repeating signal edge within the signal, wherein for each sampled occurrence of the periodically repeating signal edge, a set of samples is taken by the plurality of sampling means, the set of samples including one sample from each sampling means in the plurality of sampling means, each sample in the set of samples being taken at a different time; and,
processing means for evaluating each set of samples to estimate a length of time between when the periodically repeating signal edge was targeted to occur and when the periodically repeating signal edge was detected to occur by the plurality of samplers.

15. A system as in claim 14 wherein the processing means, for each set of samples, sets a jitter value equal to the length of time between when a periodically repeating signal edge was targeted to occur and when the periodically repeating signal edge was detected to occur by the plurality of samplers.

16. A system as in claim 14 wherein when the plurality of sampling means sample occurrences of the periodically repeating signal edge, a uniform duration of time between each sample in a set of samples is maintained, the uniform duration of time between each sample being approximately equal to what is determined to be a duration of a useable range of the periodically repeating signal edge.

17. A system as in claim 14 wherein the processing means uses a sample value from a sample in the set of samples to determine at what point in the periodically repeating signal edge the sample was taken when the sample value indicates the periodically repeating signal edge occurred at a time in which the sample was taken.

18. A system as in claim 14 the signal is serially propagated through sampling means in the plurality of sampling means.

19. A system as in claim 14 the signal is propagated in parallel through sampling means in the plurality of sampling means.

20. A system as in claim 14 wherein before sampling occurrences of the periodically repeating signal edge, the plurality of sampling means sample the signal to determine a duration of a useable range of the periodically repeating signal edge.
